(19) United States
(12) Patent Application Publication
(10) Pub. No.: US 2013/0155335 A1
(43) Pub. Date: Jun. 20, 2013

(54) ILLUMINATING DEVICE, DISPLAY DEVICE, AND TELEVISION RECEIVER

(71) Applicant: Takahiro Yoshikawa, Osaka-shi (JP)

(72) Inventor: Takahiro Yoshikawa, Osaka-shi (JP)

(73) Assignee: Sharpe Kabushiki Kaisha, Osaka-shi, Osaka (JP)

(21) Appl. No.: 13/818,134

(22) PCT Filed: May 11, 2011
(86) PCT No.: PCT/JP2011/060880

§ 371 Date: Feb. 21, 2013

(30) Foreign Application Priority Data
Aug. 24, 2010 (JP) 2010-187137

(51) Int. Cl. F21V 8/00

(52) U.S. Cl. CPC G02B 6/0011
USPC 348/790; 362/611; 362/612

(57) ABSTRACT

An illuminating device (3) includes light emitting diodes (light sources) (5) and a light guide plate (7) that directs light from the light emitting diodes (5) in a predetermined propagation direction and emits the light to a liquid crystal panel (object to be irradiated) (2). The illuminating device includes a chassis (case) (9) that houses the light emitting diodes (5) and the light guide plate (7). The chassis (9) is provided with a supporting member (support) (12) for supporting the light guide plate (7).

### TECHNICAL FIELD

The present invention relates to an illuminating device, particularly an illuminating device using a light guide plate, and a display device and a television receiver that use the illuminating device.

### BACKGROUND ART

In recent years, a display device including a liquid crystal panel as a flat display portion, as typified by a liquid crystal display device, is becoming the mainstream of, e.g., a household television receiver. The liquid crystal panel has many features such as thinness and light weight compared to a conventional Broun tube. Such a liquid crystal display device includes an illuminating device (backlight) and the liquid crystal panel. The illuminating device emits light and the liquid crystal panel displays a desired image by serving as a shutter with respect to light from a light source provided in the illuminating device. In the television receiver, information such as characters and images contained in video signals of television broadcasting is displayed on the display surface of the liquid crystal panel.

The above illuminating device is broadly divided into a direct type and an edge-light type depending on the arrangement of the light source with respect to the liquid crystal panel, which is an object to be irradiated. The recent liquid crystal display device generally uses the edge-light type, since it is easy to reduce the thickness compared to the direct type. In the edge-light type illuminating device, the light source is located on the side of the liquid crystal panel so as to reduce the thickness. Moreover, light from the light source is directed to the liquid crystal panel using a light guide plate including a light emission surface that faces the non-display surface of the liquid crystal panel.

A conventional illuminating device, as described in, e.g., Patent Document 1, includes the light guide plate, light emitting diodes (light sources) facing one side of the light guide plate, and a resin frame that is molded around the peripheral edge of the light guide plate. In this conventional illuminating device, rubber springs are placed on both ends of at least the side of the resin frame that is opposite to the light emitting diodes. The rubber springs press the light guide plate toward the light emitting diodes, thereby supporting the light guide plate. Thus, in the conventional illuminating device, the light guide plate can be stably supported, and a reduction in light emission quality such as nonuniform brightness can be prevented.

### PRIOR ART DOCUMENTS

### Patent Documents

Patent Document 1: JP 2010-153252 A

### DISCLOSURE OF INVENTION

### Problem to be Solved by the Invention

In the above conventional illuminating device, the size of the light guide plate needs to increase as the screen size of the liquid crystal panel increases.

However, when the size of the light guide plate is increased, the light guide plate may be deformed (e.g., distorted or warped). In particular, there are cases where the thickness of the light guide plate is reduced as the light guide plate becomes larger in order to suppress an increase in the weight of the light guide plate. Such a thin light guide plate is likely to be deformed by thermal expansion due to the ambient temperature, for example. Thus, the conventional illuminating device can cause deformation of the light guide plate when the size of the light guide plate is increased. Consequently, in the conventional illuminating device, nonuniform brightness or the like occurs, and thus the light emission quality is reduced.

With the foregoing in mind, it is an object of the present invention to provide an illuminating device that has excellent light emission quality and can prevent deformation of a light guide plate even if the size of the light guide plate is increased, and a display device and a television receiver that use the illuminating device.

### Means for Solving Problem

To achieve the above object, an illuminating device of the present invention includes a light source and a light guide plate that directs light from the light source in a predetermined propagation direction and emits the light to an object to be irradiated. The illuminating device includes a case that houses the light source and the light guide plate. The case is provided with a support for supporting the light guide plate.

In the illuminating device with the above configuration, the case houses the light source and the light guide plate. Moreover, the case is provided with the support for supporting the light guide plate. Thus, unlike the conventional example, the illuminating device can prevent deformation such as distortion or warpage of the light guide plate even if the size of the light guide plate is increased. Consequently, it is possible to prevent the occurrence of nonuniform brightness or the like due to the deformation, and thus to provide the illuminating device with excellent light emission quality.

In the above illuminating device, it is preferable that the support includes a supporting member that supports a central portion of the light guide plate.

In this case, deformation of the light guide plate can be prevented reliably.

In the above illuminating device, it is preferable that the support includes a plurality of supporting members.

In this case, deformation of the light guide plate can be prevented more reliably.

In the above illuminating device, the support may include a supporting member that is provided along a long-side direction of the light guide plate.

In this case, distortion or the like of the light guide plate in the long-side direction can be prevented reliably.

In the above illuminating device, it is preferable that the support includes a linear supporting member.

In this case, deformation of the light guide plate can be prevented more reliably while the number of placement of supporting members is suppressed.

In the above illuminating device, a supporting member that is discretely formed on the case is used as the support.

In this case, the supporting member can be appropriately and easily positioned with respect to the light guide plate without requiring special processing of the case.

In the above illuminating device, it is preferable that the light guide plate includes a light incident surface for receiving light from the light source, a light emission surface from which the light that has entered from the light incident surface is emitted to the object to be irradiated, and an opposite surface that is opposite to the light emission surface, and that a reflecting member is provided on the opposite surface of the light guide plate and reflects light passing through the inside of the light guide plate toward the light emission surface, and that the support supports the light guide plate with the reflecting member interposed between the support and the light guide plate.

In this case, the light from the light source can be efficiently emitted to the object to be irradiated by the reflecting member, and the support can prevent the light guide plate and the reflecting member from being deformed. Therefore, it is possible to reliably prevent the occurrence of nonuniform brightness on the light emission surface of the light guide plate, and thus to easily provide the illuminating device with excellent light emission quality.

In the above illuminating device, it is preferable that a frame-shaped body is provided in contact with the edge of the light emission surface of the light guide plate.

In this case, the light guide plate can be sandwiched between the support and the frame-shaped body, and the frame-shaped body can reliably prevent the end portions of the light guide plate from being warped, so that deformation of the light guide plate can be prevented more reliably.

In the above illuminating device, it is preferable that a light emitting diode is used as the light source.

In this case, the illuminating device with low power consumption and excellent environmental performance can be easily provided.

A display device of the present invention includes any one of the above illuminating devices.

A television receiver of the present invention includes the above display device.

The display device and the television receiver with the above configurations use the illuminating device that has excellent light emission quality and can prevent deformation of a light guide plate even if the size of the light guide plate is increased. Thus, the display device and the television receiver can easily achieve a large screen and high performance.

### Effects of the Invention

The present invention can provide an illuminating device that has excellent light emission quality and can prevent deformation of a light guide plate even if the size of the light guide plate is increased, and a display device and a television receiver that use the illuminating device.

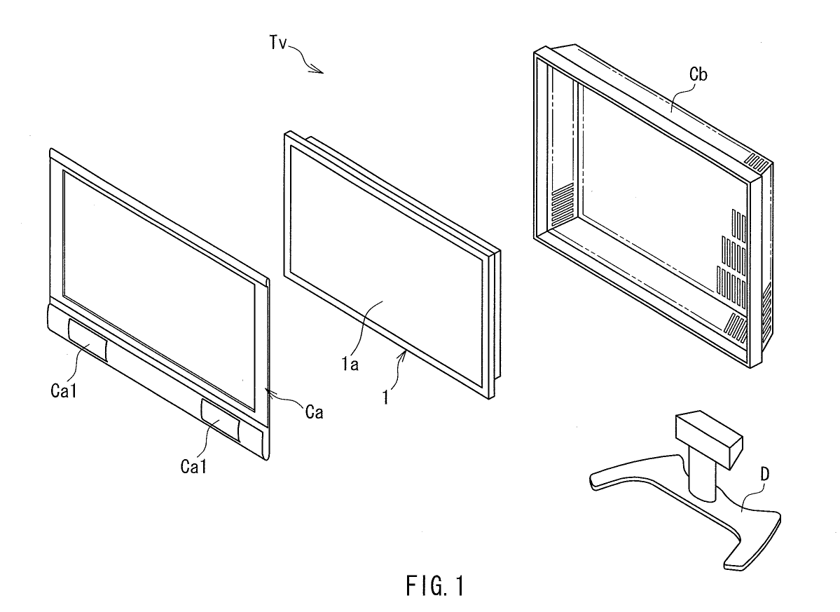

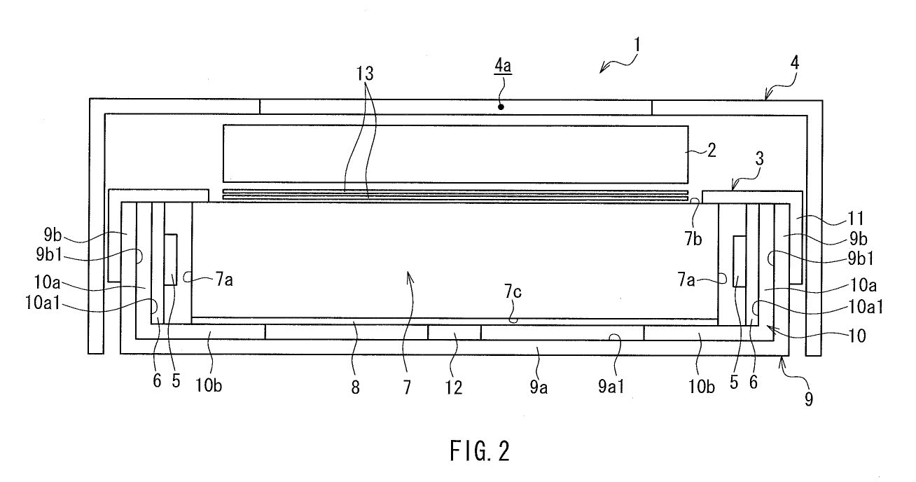

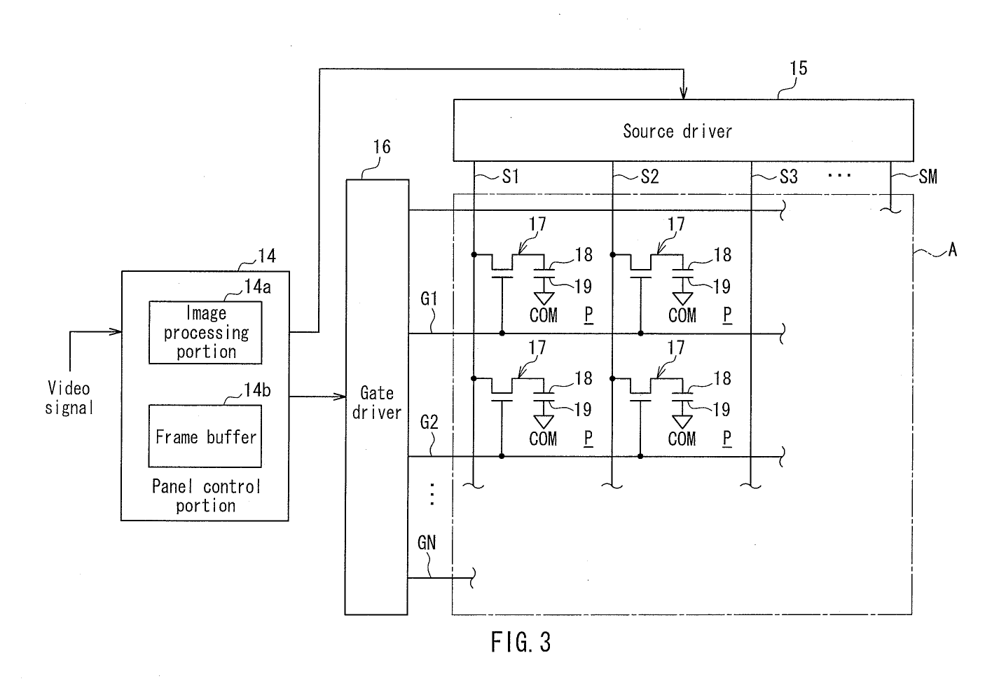

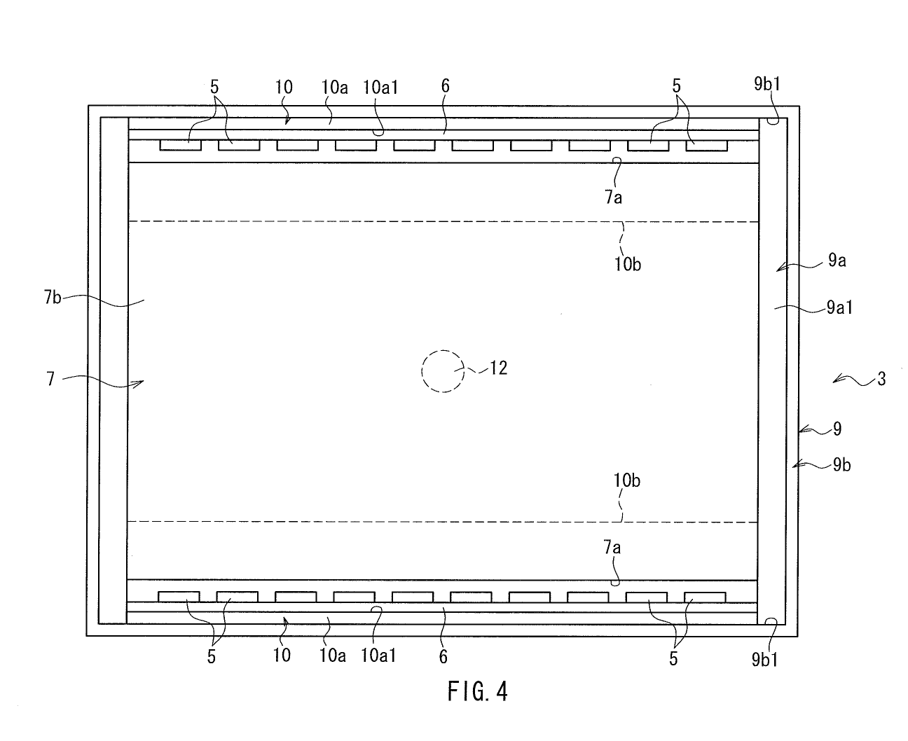

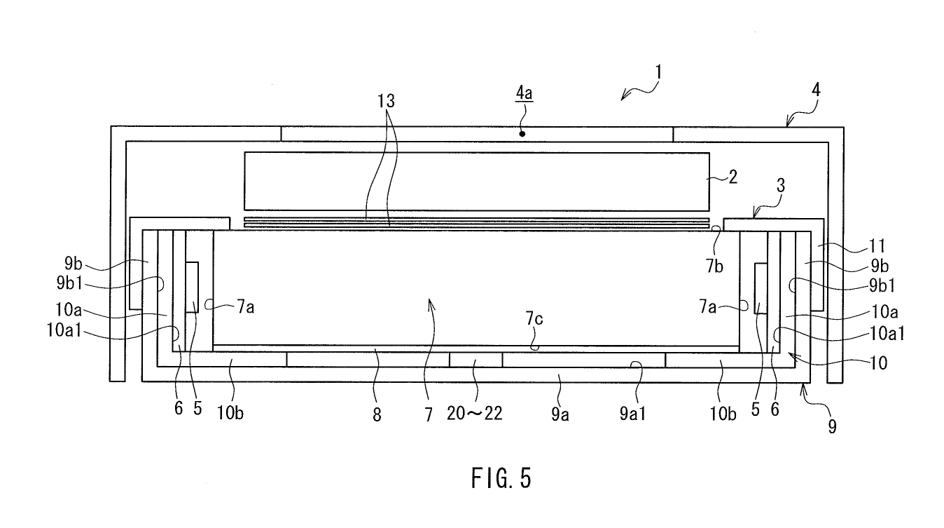

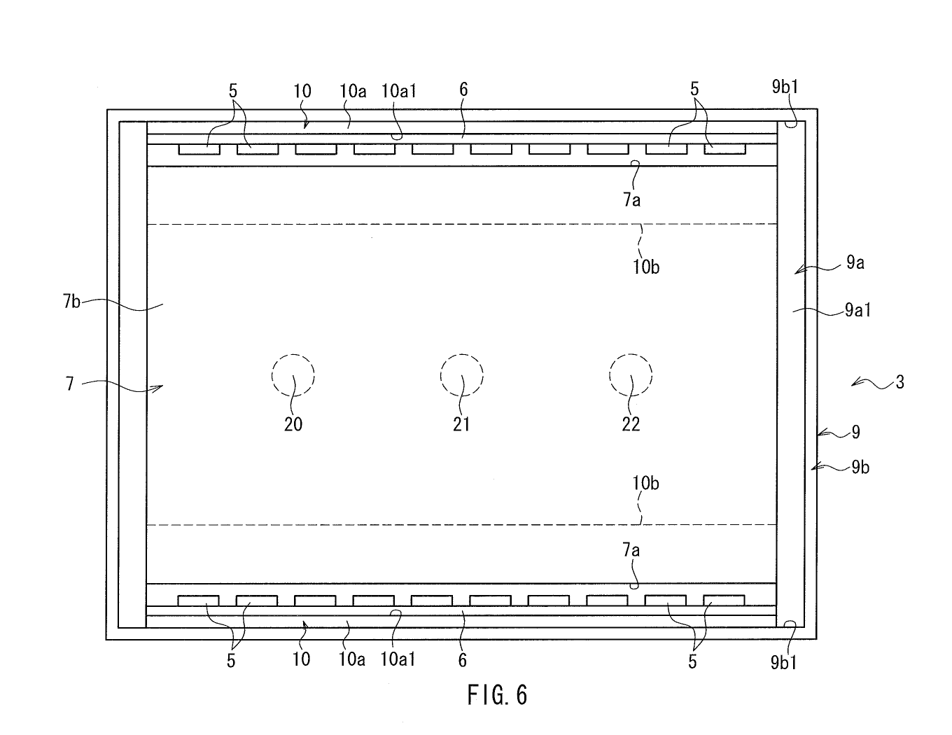

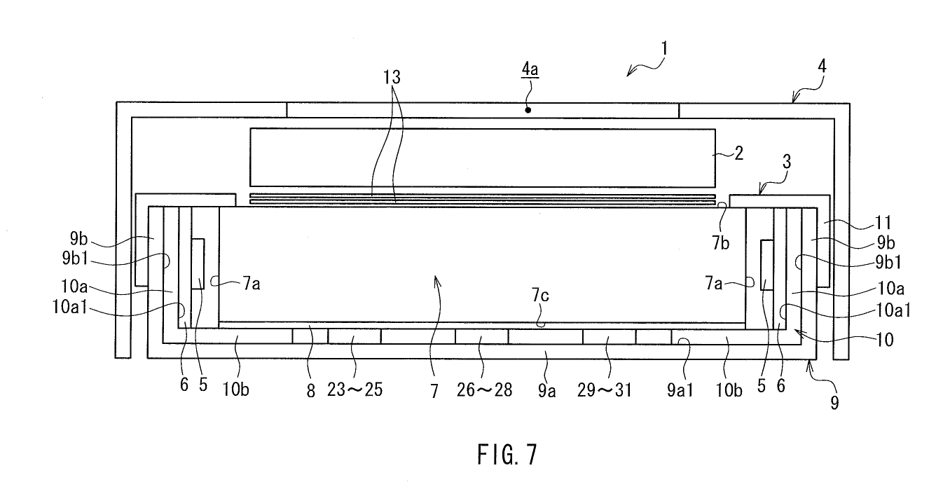

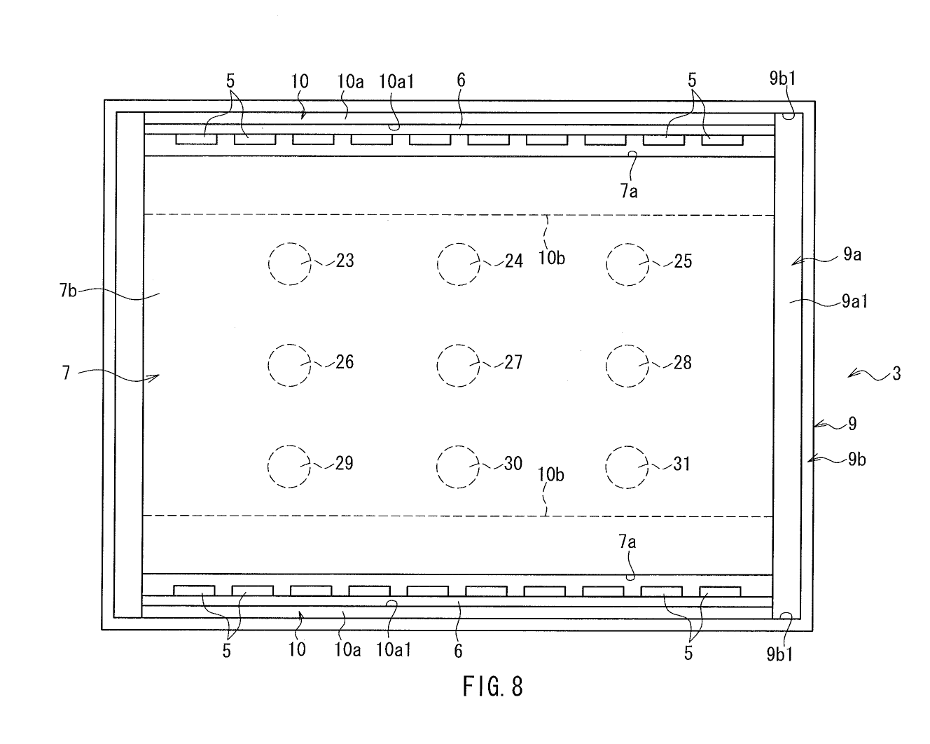

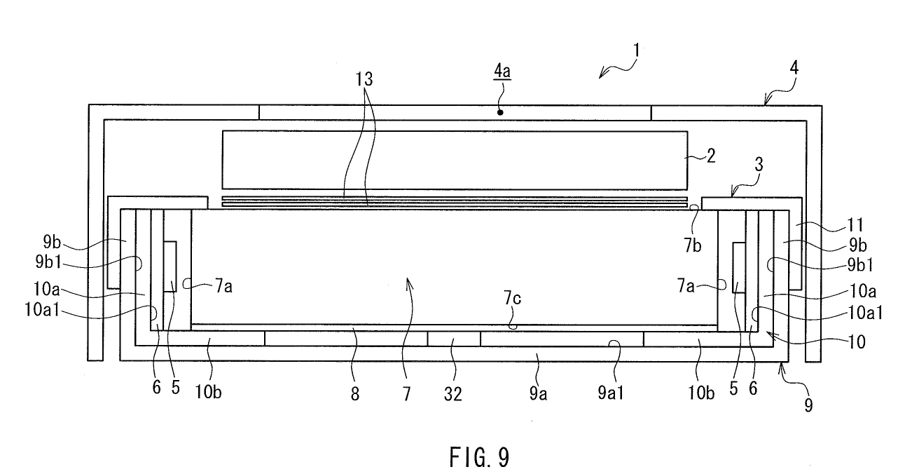

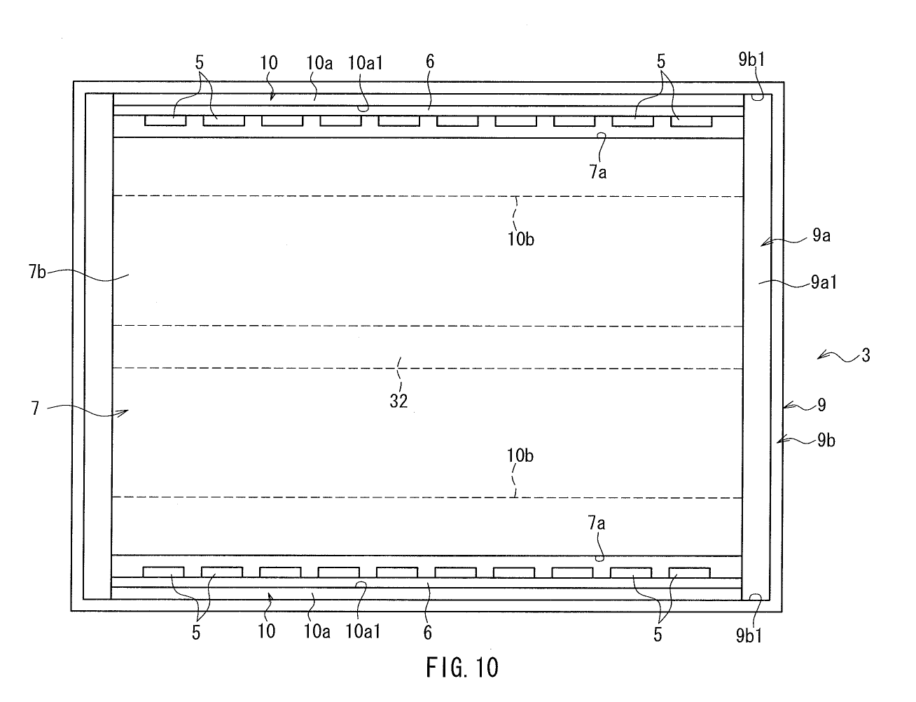

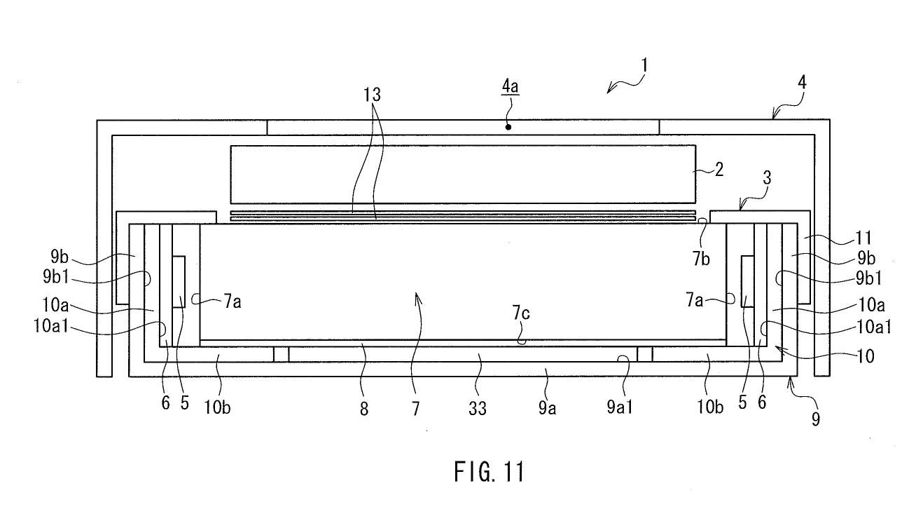

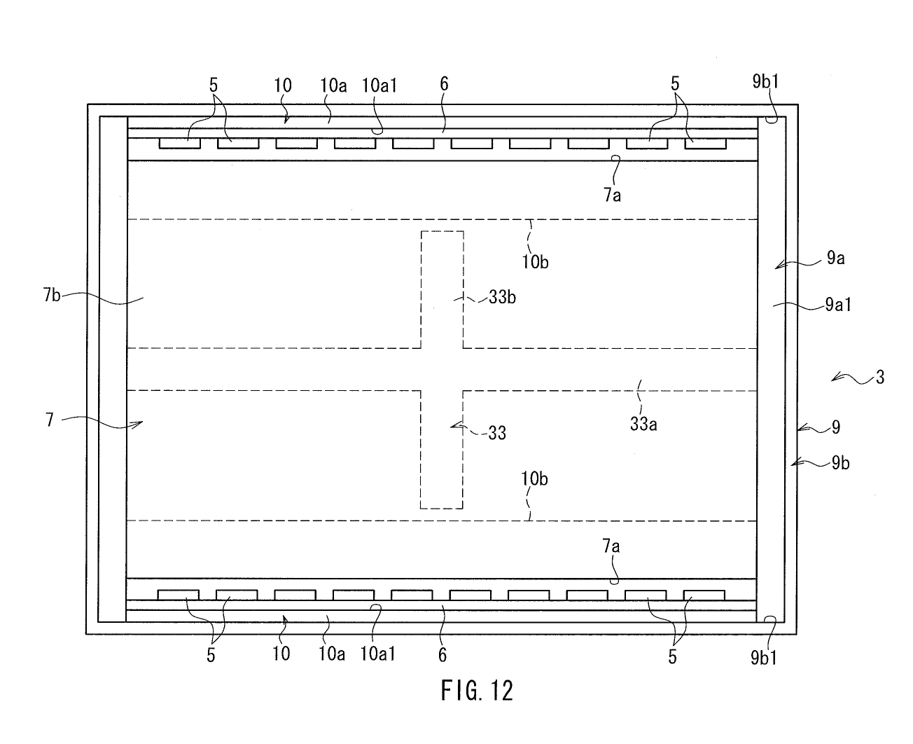

### BRIEF DESCRIPTION OF DRAWINGS

[FIG. 1] FIG. 1 is an exploded perspective view showing a television receiver and a liquid crystal display device according to Embodiment 1 of the present invention.

[FIG. 2] FIG. 2 is diagram for explaining the main configuration of the liquid crystal display device.

[FIG. 3] FIG. 3 is a diagram for explaining the configuration of a liquid crystal panel shown in FIG. 2.

[FIG. 4] FIG. 4 is a plan view of an illuminating device shown in FIG. 2.

[FIG. 5] FIG. 5 is a diagram for explaining the main configuration of a liquid crystal display device according to Embodiment 2 of the present invention.

[FIG. 6] FIG. 6 is a plan view of an illuminating device shown in FIG. 5.

[FIG. 7] FIG. 7 is a diagram for explaining the main configuration of a liquid crystal display device according to Embodiment 3 of the present invention.

[FIG. 8] FIG. 8 is a plan view of an illuminating device shown in FIG. 7.

[FIG. 9] FIG. 9 is a diagram for explaining the main configuration of a liquid crystal display device according to Embodiment 4 of the present invention.

[FIG. 10] FIG. 10 is a plan view of an illuminating device shown in FIG. 9.

[FIG. 11] FIG. 11 is a diagram for explaining the main configuration of a liquid crystal display device according to Embodiment 5 of the present invention.

[FIG. 12] FIG. 12 is a plan view of an illuminating device shown in FIG. 11.

### DESCRIPTION OF THE INVENTION

Hereinafter, preferred embodiments of an illuminating device, a display device, and a television receiver of the present invention will be described with reference to the drawings. In the following description, the present invention is applied to a transmission-type liquid crystal display device. The size and size ratio of each of the constituent members in the drawings do not exactly reflect those of the actual constituent members.

### Embodiment 1

FIG. 1 is an exploded perspective view showing a television receiver and a liquid crystal display device according to Embodiment 1 of the present invention. In FIG. 1, a television receiver Tv of this embodiment includes a liquid crystal display device 1 as a display device and is configured to be able to receive television broadcasting with an antenna, a cable, etc. (not shown). The liquid crystal display device 1 is housed in a front cabinet Ca and a back cabinet Cb, and placed upright on a stand D. In the television receiver Tv, a display surface la of the liquid crystal display device 1 can be seen via the front cabinet Ca. The display surface la is located parallel to the direction in which gravity acts (i.e., the vertical direction) by the stand D.

In the television receiver Tv, images in accordance with video signals of the television broadcasting are received by a TV tuner (not shown) and displayed on the display surface 1a, and sound is reproduced and output from speakers Ca1 provided in the front cabinet Ca. The back cabinet Cb has many air holes through which heat generated in an illuminating device or a power supply can be appropriately dissipated.

Next, the liquid crystal display device 1 of this embodiment will be described in detail with reference to FIG. 2.

FIG. 2 is a diagram for explaining the main configuration of the liquid crystal display device.

In FIG. 2, the liquid crystal display device 1 of this embodiment includes a liquid crystal panel 2 and an illuminating device 3 of the present invention. The liquid crystal panel 2 is placed so that the upper side of FIG. 2 is identified as a viewer side (i.e., the display surface side). The illuminating device 3 is placed on the non-display surface side of the liquid crystal panel 2 (i.e., the lower side of FIG. 2) and irradiates the liquid crystal panel 2 with illumination light. In the liquid crystal display device 1, the liquid crystal panel 2 and the illuminating device 3 are joined together within a bezel 4, which has an L-shaped cross section. Thus, the liquid crystal panel 2 and the illuminating device 3 are integrated into the transmission-type liquid crystal display device 1 in which the illumination light from the illuminating device 3 enters the liquid crystal panel 2.

In the liquid crystal display device 1, the display surface 1a is defined by a rectangular opening 4a formed in the bezel 4. In other words, the display surface of the liquid crystal panel 2 that can be seen through the opening 4a constitutes the display surface 1a.

Although not shown in FIG. 2, the liquid crystal panel 2 includes a liquid crystal layer, a color filter substrate and an active matrix substrate that are a pair of substrates sandwiching the liquid crystal layer, and polarizing plates that are provided on the outer surfaces of the color filter substrate and the active matrix substrate, respectively (not shown). In the liquid crystal panel 2, the polarization state of the illumination light that has entered through the polarizing plate provided on the illuminating device 3 side is modulated by the liquid crystal layer, and the amount of light passing through the polarizing plate provided on the opening 4a side (i.e., the display surface 1a side) is controlled, thereby displaying a desired image.

Next, the liquid crystal panel 2 of this embodiment will be described in detail with reference to FIG. 3 as well as FIG. 2.

FIG. 3 is a diagram for explaining the configuration of the liquid crystal panel shown in FIG. 2.

In FIG. 3, the liquid crystal display device 1 (FIG. 2) includes a panel control portion 14 that performs drive control of the liquid crystal panel 2 (FIG. 2) serving as a display portion that displays information such as characters and images, and a source driver 15 and a gate driver 16 that are operated based on instruction signals from the panel control portion 14.

The panel control portion 14 is provided in a control unit (not shown) of the liquid crystal display device 1 and receives the video signals from the outside of the liquid crystal display device 1. Moreover, the panel control portion 14 includes an image processing portion 14a and a frame buffer 14b. The image processing portion 14a performs predetermined image processing on the input video signals and generates instruction signals for the source driver 15 and the gate drive 16. The frame buffer 14b can store a frame of display data contained in the input video signals. The panel control portion 14 performs drive control of the source driver 15 and the gate driver 16 in accordance with the input video signals so that the liquid crystal panel 2 displays information in accordance with those video signals.

The source driver 15 and the gate driver 16 are placed, e.g., on the active matrix substrate. Specifically, on the surface of the active matrix substrate, the source driver 15 is located outside an effective display region A of the liquid crystal panel (display panel) 2 along the lateral direction of the liquid crystal panel 2. Moreover, on the surface of the active matrix substrate, the gate driver 16 is located outside the effective display region A of the liquid crystal panel 2 along the longitudinal direction of the liquid crystal panel 2.

The source driver 15 and the gate driver 16 are drive circuits for driving a plurality of pixels P of the liquid crystal panel 2 pixel by pixel. A plurality of source lines S1 to SM (M is an integer of 2 or more, and the source lines are generically called “S” in the following) are connected to the source driver 15. A plurality of gate lines G1 to GN (N is an integer of 2 or more, and the gate lines are generically called “G” in the following) are connected to the gate driver 16. The source lines S and the gate lines G constitute data lines and scanning lines, respectively. Moreover, the source lines S and the gate lines G are arranged in a matrix so as to intersect with each other on a transparent glass material or a transparent synthetic resin base material (not shown) included in the active matrix substrate. Specifically, the source lines S are provided on the base material and extend parallel to the column direction of the matrix (i.e., the longitudinal direction of the liquid crystal panel 2). The gate lines G are provided on the base material and extend parallel to the row direction of the matrix (i.e., the lateral direction of the liquid crystal panel 2).

The pixels P are provided in the vicinity of each of the intersections of the source lines S and the gate lines G. Each of the pixels P includes a thin film transistor (switching element) 17 and a pixel electrode 18 connected to the thin film transistor 17. Each of the pixels P also includes a common electrode 19 that is located opposite to the pixel electrode 18 with the liquid crystal layer of the liquid crystal panel 2 interposed between them. In the active matrix substrate, the thin film transistor 17, the pixel electrode 18, and the common electrode 19 are provided per pixel.

Moreover, in the active matrix substrate, the plurality of pixels P are formed in the areas that are arranged in a matrix and separated from one another by the source lines S and the gate lines G. The pixels P include red (R), green (G), and blue (B) pixels. The RGB pixels are successively arranged, e.g., in this order in the direction parallel to the gate lines G1 to GN. The RGB pixels are capable of displaying the corresponding colors due to a color filter layer (not shown) provided on the color filter substrate.

In the active matrix substrate, based on the instruction signal from the image processing portion 14a, the gate driver 16 outputs scanning signals (gate signals) in sequence to the gate lines G1 to GN so that the gate electrode of the corresponding thin film transistor 17 is brought into the on state. Moreover, based on the instruction signal from the image processing portion 14a, the source driver 15 outputs data signals (voltage signals (gradation voltages)) in accordance with the brightness (gradation) of the display image to the corresponding source lines S1 to SM.

Next, the illuminating device 3 of this embodiment will be described in detail with reference to FIGS. 2 and 4.

FIG. 4 is a plan view of the illuminating device shown in FIG. 2.

As shown in FIGS. 2 and 4, the illuminating device 3 of this embodiment includes light emitting diodes (light sources) 5, an LED substrate (light source substrate) 6 on which the light emitting diodes 5 are mounted, and a light guide plate 7 that receives light from the light emitting diodes 5. The light emitting diodes 5 can be, e.g., white (W) light emitting diodes that emit white light. As shown in FIG. 4, the illuminating device 3 of this embodiment includes two LED substrates 6, on each of which a plurality of, e.g., ten light emitting diodes 5 are mounted in a line and spaced at predetermined intervals.

The light guide plate 7 can be, e.g., a transparent synthetic resin such as an acrylic resin or a transparent glass material with a thickness of about 1.5 mm to 4.0 mm, and receives light from the light emitting diodes (light sources) 5. Two opposing side faces of the light guide plate 7 function as light incident surfaces 7a where the light from the light emitting diodes 5 enters. Moreover, a reflecting sheet 8 may be provided on the side of the light guide plate 7 that faces away from the liquid crystal panel 2 (i.e., an opposite surface 7c that is opposite to a light emission surface 7b, as will be described later). The reflecting sheet 8 constitutes a reflecting member that reflects light passing through the inside of the light guide plate 7 toward the light emission surface 7b.

The light guide plate 7 emits light from the light emission surface 7b, which faces the liquid crystal panel 2, to the liquid crystal panel (object to be irradiated) 2, while directing the light from the light emitting diodes 5 in a predetermined propagation direction (i.e., the lateral direction of FIG. 2). Moreover, optical sheets 13 such as a lens sheet and a diffusing sheet are provided on the side of the light guide plate 7 that faces the liquid crystal panel 2 (i.e., the light emission surface 7b). The optical sheets 13 are used to convert the light that has been emitted from the light emitting diodes 5 and directed in the propagation direction in the light guide plate 7 into planar illumination light with uniform brightness, and then the illumination light enters the liquid crystal panel 2.

As shown in FIG. 2, the illuminating device 3 of this embodiment includes a chassis 9 that has a bottom and is open to the liquid crystal panel 2 side, and a heat spreader 10 serving as a heat dissipation member that is discretely (individually) formed on the chassis 9. The illuminating device 3 of this embodiment also includes a P (plastic) chassis 11 that has a rectangular opening and is attached to the edge portion of the chassis 9, and a supporting member 12 that is included in a support for supporting the light guide plate 7.

The chassis 9 is made of, e.g., a metal material such as a galvanized steel plate. The chassis 9 includes a flat bottom 9a and side portions 9b that are provided on four sides of the bottom 9a so as to stand vertically on the bottom 9a. Thus, the chassis 9 constitutes a case that houses the light emitting diodes (light sources) 5 and the light guide plate 7. Moreover, the chassis 9 dissipates heat that has been transferred from the light emitting diodes 5 via the heat spreader 10.

The heat spreader 10 is made of a metal material with excellent heat dissipation performance such as aluminum. Referring also to FIG. 4, the heat spreader 10 includes a side portion 10a and a bottom 10b that are at right angles to each other, and has an L-shaped cross section. Each of the two LED substrates (light source substrates) 6 is mounted on a mounting surface 10a1 of the side portion 10a of the heat spreader 10. Moreover, the heat spreader 10 is attached to the chassis 9 so that heat generated from the light emitting diodes 5 can be dissipated. Specifically, the side portion 10a of the heat spreader 10 is mounted on a mounting surface 9b1 each of the side portions 9b of the chassis 9, and the bottom 10b of the heat spreader 10 is mounted on a bottom surface 9a1 of the bottom 9a of the chassis 9.

The P chassis 11 is a frame-shaped body provided in contact with the edge of the light emission surface 7b of the light guide plate 7. The optical sheets 13 are disposed in the opening of the P chassis 11 and used, e.g., to increase the brightness of light emanating from the light emission surface 7b of the light guide plate 7 before the light enters the liquid crystal panel 2.

The supporting member 12 is made of, e.g., a metal material such as a galvanized steel plate or a synthetic resin material such as an acrylic resin. The supporting member 12 is fixed to the chassis 9 with a fixing member such as an adhesive, a double-sided tape, or a screw. Other than the method of using the fixing member, the supporting member 12 may be fixed to the chassis 9, e.g., by forming a protrusion and a hole in the supporting member 12 and the chassis 9, respectively, and fitting or engaging the protrusion and the hole together (the same is true for the supporting member in each of the following embodiments). As shown in FIGS. 2 and 4, the supporting member 12 has, e.g., a cylindrical shape and supports the central portion of the light guide plate 7 with the reflecting sheet (reflecting member) 8 interposed between them.

In the illuminating device 3 of this embodiment with the above configuration, the chassis (case) 9 houses the light emitting diodes (light sources) 5 and the light guide plate 7. Moreover, the chassis 9 is provided with the supporting member 12 that is included in the support for supporting the light guide plate 7. Thus, unlike the conventional example, the illuminating device 3 of this embodiment can prevent deformation such as distortion or warpage of the light guide plate 7 even if the size of the light guide plate 7 is increased. Consequently, this embodiment can prevent the occurrence of nonuniform brightness or the like due to the deformation, and thus can provide the illuminating device 3 with excellent light emission quality.

In the illuminating device 3 of this embodiment, since the supporting member 12 supports the central portion of the light guide plate 7, deformation of the light guide plate 7 can be prevented reliably.

In the illuminating device 3 of this embodiment, the light guide plate 7 includes the light incident surfaces 7a for receiving light from the light emitting diodes 5, the light emission surface 7b from which the light that has entered from the light incident surfaces 7a is emitted to the liquid crystal panel (object to be irradiated) 2, and the opposite surface 7c that is opposite to the light emission surface 7b. Moreover, the reflecting sheet (reflecting member) 8 is provided on the opposite surface 7c of the light guide plate 7 and reflects light passing through the inside of the light guide plate 7 toward the light emission surface 7b. Further, in the illuminating device 3 of this embodiment, the supporting member 12 supports the light guide plate 7 with the reflecting sheet 8 interposed between them. Thus, in this embodiment, the light from the light emitting diodes 5 can be efficiently emitted to the liquid crystal panel 2 by the reflecting sheet 8, and the supporting member 12 can prevent the light guide plate 7 and the reflecting sheet 8 from being deformed. Therefore, this embodiment can reliably prevent the occurrence of nonuniform brightness on the light emission surface 7b of the light guide plate 7, and thus can easily provide the illuminating device 3 with excellent light emission quality.

In the illuminating device 3 of this embodiment, the P chassis (frame-shaped body) 11 is provided in contact with the edge of the light emission surface 7b of the light guide plate 7. Therefore, the light guide plate 7 can be sandwiched between the supporting member 12 and the P chassis 11, and the P chassis 11 can reliably prevent the end portions of the light guide plate 7 from being warped, so that deformation of the light guide plate 7 can be prevented more reliably.

This embodiment uses the illuminating device 3 that has excellent light emission quality and can prevent deformation of the light guide plate 7 even if the size of the light guide plate 7 is increased. Therefore, this embodiment can easily provide the liquid crystal display device (display device) 1 and the television receiver Tv with a large screen and high performance.

Other than the above description, e.g., the supporting member 12 may be formed on the opposite surface 7c of the light guide plate 7. With this condition, however, the light guide plate 7 requires special processing to form the supporting member 12, which results in a great increase in cost compared to the case where the supporting member 12 is formed on the chassis 9. Moreover, this configuration may lead to a reduction in optical performance of the light guide plate 7 such that nonuniform brightness or the like is likely to occur on the light emission surface 7b.

### Embodiment 2

FIG. 5 is a diagram for explaining the main configuration of a liquid crystal display device according to Embodiment 2 of the present invention. FIG. 6 is a plan view of an illuminating device shown in FIG. 5. In FIGS. 5 and 6, this embodiment mainly differs from Embodiment 1 in that the number of placement of supporting members is increased. The same components as those in Embodiment 1 are denoted by the same reference numerals, and the explanation will not be repeated.

As shown in FIGS. 5 and 6, in the illuminating device 3 of this embodiment, a plurality of, e.g., three supporting members 20, 21, and 22 are attached to the chassis (case) 9 and support the light guide plate 7. The supporting members 20 to 22 are included in the support for supporting the light guide plate 7 with the reflecting sheet (reflecting member) 8 interposed between them. Each of the supporting members 20 to 22 is, e.g., in the form of a cylinder. Moreover, the supporting members 20 to 22 are provided along the long-side direction of the light guide plate 7. The supporting member 21 supports the central portion of the light guide plate 7.

With the above configuration, this embodiment can have the effects comparable to those of Embodiment 1. In this embodiment, since the support includes the plurality of supporting members 20 to 22, deformation of the light guide plate 7 can be prevented more reliably compared to Embodiment 1. Moreover, the supporting members 20 to 22 are provided along the long-side direction of the light guide plate 7, and thus distortion or the like of the light guide plate 7 in the long-side direction can be prevented reliably.

### Embodiment 3

FIG. 7 is a diagram for explaining the main configuration of a liquid crystal display device according to Embodiment 3 of the present invention. FIG. 8 is a plan view of an illuminating device shown in FIG. 7. In FIGS. 7 and 8, this embodiment mainly differs from Embodiment 2 in that the number of placement of supporting members is increased. The same components as those in Embodiment 2 are denoted by the same reference numerals, and the explanation will not be repeated.

As shown in FIGS. 7 and 8, in the illuminating device 3 of this embodiment, a plurality of, e.g., nine supporting members 23, 24, 25, 26, 27, 28, 29, 30, and 31 are attached to the chassis (case) 9 and support the light guide plate 7. The supporting members 23 to 31 are included in the support for supporting the light guide plate 7 with the reflecting sheet (reflecting member) 8 interposed between them. Each of the supporting members 23 to 31 is, e.g., in the form of a cylinder. Moreover, the supporting members 23 to 25 are provided along the long-side direction of the light guide plate 7. Similarly, the supporting members 26 to 28 are provided along the long-side direction of the light guide plate 7, and the supporting members 29 to 31 are provided along the long-side direction of the light guide plate 7. The supporting members 24, 27, and 30 support the central portion of the light guide plate 7.

With the above configuration, this embodiment can have the effects comparable to those of Embodiment 2. In this embodiment, since the number of placement of supporting members is larger than that in Embodiment 2, deformation of the light guide plate 7 can be prevented more reliably compared to Embodiment 2.

### Embodiment 4

FIG. 9 is a diagram for explaining the main configuration of a liquid crystal display device according to Embodiment 4 of the present invention. FIG. 10 is a plan view of an illuminating device shown in FIG. 9. In FIGS. 9 and 10, this embodiment mainly differs from Embodiment 1 in that a linear supporting member is provided. The same components as those in Embodiment 1 are denoted by the same reference numerals, and the explanation will not be repeated.

As shown in FIGS. 9 and 10, in the illuminating device 3 of this embodiment, e.g., a linear supporting member 32 is attached to the chassis (case) 9 and supports the light guide plate 7. The supporting member 32 is included in the support for supporting the light guide plate 7 with the reflecting sheet (reflecting member) 8 interposed between them. The supporting member 32 is, e.g., in the form of a quadrangular prism. Moreover, the supporting member 32 is provided along the long-side direction of the light guide plate 7 so as to support the central portion of the light guide plate 7.

With the above configuration, this embodiment can have the effects comparable to those of Embodiment 1. In this embodiment, since the support includes the linear supporting member 32, deformation of the light guide plate 7 can be prevented more reliably compared to Embodiment 1 while the number of placement of supporting members is suppressed.

### Embodiment 5

FIG. 11 is a diagram for explaining the main configuration of a liquid crystal display device according to Embodiment 5 of the present invention. FIG. 12 is a plan view of an illuminating device shown in FIG. 11. In FIGS. 11 and 12, this embodiment mainly differs from Embodiment 4 in that a supporting member is provided parallel to the short-side direction of the light guide plate in addition to the supporting member provided parallel to the long-side direction of the light guide plate. The same components as those in Embodiment 4 are denoted by the same reference numerals, and the explanation will not be repeated.

As shown in FIGS. 11 and 12, in the illuminating device 3 of this embodiment, e.g., a cross supporting member 33 is attached to the chassis (case) 9 and supports the light guide plate 7. The supporting member 33 is included in the support for supporting the light guide plate 7 with the reflecting sheet (reflecting member) 8 interposed between them. The supporting member 33 includes a linear supporting member 33a provided parallel to the long-side direction of the light guide plate 7 and a linear supporting member 33b provided parallel to the short-side direction of the light guide plate 7. The supporting members 33a, 33b are, e.g., in the form of a quadrangular prism. Moreover, the supporting member 33 supports the central portion of the light guide plate 7.

With the above configuration, this embodiment can have the effects comparable to those of Embodiment 4. In this embodiment, since the supporting member 33b is provided parallel to the short-side direction of the light guide plate 7 in addition to the supporting member 33a provided parallel to the long-side direction of the light guide plate 7, deformation of the light guide plate 7 can be prevented more reliably compared to Embodiment 4.

It should be noted that the above embodiments are all illustrative and not restrictive. The technological scope of the present invention is defined by the appended claims, and all changes that come within the range of equivalency of the claims are intended to be embraced therein.

In the above description, e.g., the present invention is applied to the transmission type liquid crystal display device. However, the illuminating device of the present invention is not limited thereto, and may be applied to various display devices including a semi-transmission type liquid crystal display device and a projection type display device using the liquid crystal panel as a light valve.

Other than the above description, the present invention can be suitably used as an illuminating device of, e.g., a film viewer for irradiating x-ray radiographs with light, a light box for irradiating negatives or the like with light to ensure better viewability, or a light emitting device for illuminating signboards, advertisements installed on the wall surfaces in the station precinct.

In the above description, the supporting member that is discretely formed on the chassis (case) is used as the support. However, the illuminating device of the present invention is not limited thereto, as long as it includes the case that houses the light source and the light guide plate, and the case is provided with the support for supporting the light guide plate. Moreover, the support may be integrally formed with the case.

As described in each of the above embodiments, the use of the supporting member that is discretely formed on the case is preferred because the supporting member can be appropriately and easily positioned with respect to the light guide plate without requiring special processing of the case.

In the above description, the LED substrates (light source substrates), on each of which the light emitting diodes (light sources) are mounted, are provided on the chassis (case) via the heat spreader (heat dissipation member). However, the illuminating device of the present invention is not limited thereto, and the light source substrates may be provided on the case without placing the heat dissipation member between them.

In the above description, a plurality of light emitting diodes (light sources) are arranged in a line so as to face each of the two opposing side faces of the light guide plate. However, the illuminating device of the present invention is not limited thereto, as long as it includes the light source and the light guide plate that directs light from the light source in a predetermined propagation direction and emits the light to the object to be irradiated. For example, the light source may be located so as to face one side face of the light guide plate. Moreover, multiple rows of light sources may be located so as to face one side face of the light guide plate.

In the above description, white light emitting diodes are used as the light sources. However, the light sources of the present invention are not limited thereto, and may include, e.g., discharge tubes such as a cold-cathode fluorescent tube and a hot-cathode fluorescent tube, lamps such as an electric lamp, and light emitting devices such as an organic EL (electronic luminescence) device and an inorganic EL device.

As described in each of the above embodiments, the use of the light emitting diodes is preferred because the illuminating device with low power consumption and excellent environmental performance can be easily provided.

The light emitting diodes of the present invention are not limited to the white light emitting diodes, and can be, e.g., so-called 3-in-1 type light emitting diodes obtained by combining RGB light emitting diodes, or so-called four-in-one (4-in-1) type light emitting diodes obtained by combining four light emitting diodes such as RGBW or GRGB. Alternatively, the light emitting diodes of different R, G, and B colors can be used individually.

Other than the above description, Embodiments 1 to 5 may be combined as needed.

### INDUSTRIAL APPLICABILITY

The present invention is useful for an illuminating device that has excellent light emission quality and can prevent deformation of a light guide plate even if the size of the light guide plate is increased, and a display device and a television receiver that use the illuminating device.

### DESCRIPTION OF REFERENCE NUMERALS

1 Liquid crystal display device (display device)

2 Liquid crystal panel (object to be irradiated)

3 Illuminating device

5 Light emitting diode (light source)

7 Light guide plate

7a Light incident surface

7b Light emission surface

7c Opposite surface

8 Reflecting sheet (reflecting member)

9 Chassis (case)

11 P chassis (frame-shaped body)

12, 20 to 33 Supporting member (support)

Tv Television receiver

1. An illuminating device comprising:
a light source; and
a light guide plate that directs light from the light source in a predetermined propagation direction and emits the light to an object to be irradiated,
wherein the illuminating device includes a case that houses the light source and the light guide plate, and
the case is provided with a support for supporting the light guide plate.

2. The illuminating device according to claim 1, wherein the support includes a supporting member that supports a central portion of the light guide plate.

3. The illuminating device according to claim 1, wherein the support includes a plurality of supporting members.

4. The illuminating device according to claim 1, wherein the support includes a supporting member that is provided along a long-side direction of the light guide plate.

5. The illuminating device according to claim 1, wherein the support includes a linear supporting member.

6. The illuminating device according to claim 1, wherein a supporting member that is discretely formed on the case is used as the support.

7. The illuminating device according to claim 1, wherein the light guide plate includes a light incident surface for receiving light from the light source, a light emission surface from which the light that has entered from the light incident surface is emitted to the object to be irradiated, and an opposite surface that is opposite to the light emission surface,
wherein a reflecting member is provided on the opposite surface of the light guide plate and reflects light passing through an inside of the light guide plate toward the light emission surface, and
wherein the support supports the light guide plate with the reflecting member interposed between the support and the light guide plate.

8. The illuminating device according to claim 7, wherein a frame-shaped body is provided in contact with an edge of the light emission surface of the light guide plate.

9. The illuminating device according to claim 1, wherein a light emitting diode is used as the light source.

10. A display device comprising the illuminating device according to claim 1.

11. A television receiver comprising the display device according to claim 10.
